(19) United States
(12) Patent Application Publication
(10) Pub. No.: US 2010/0124194 A1
(43) Pub. Date: May 20, 2010

(54) METHOD OF TRANSMITTING BROADCAST INFORMATION IN WIRELESS COMMUNICATION SYSTEM

(76) Inventors: Jin Young Chun, Gyeongki-do (KR); Bin Chul Ihm, Gyeongki-do (KR); Wook Bong Lee, Gyeongki-do (KR); Moon Il Lee, Gyeongki-do (KR); Hyun Soo Ko, Gyeongki-do (KR); Sung Ho Park, Gyeongki-do (KR)

Correspondence Address: MCKENNA LONG & ALDRIDGE LLP, 1900 K STREET, NW, WASHINGTON, DC, 20006, US

(21) Appl. No.: 12/450,993

(22) PCT Filed: Apr. 28, 2008
(86) PCT No.: PCT/KR2008/002387

§ 371 Date: Oct. 21, 2009

(30) Foreign Application Priority Data
Apr. 27, 2007 (KR) 10-2007-0041149

(51) Int. Cl. H04W 40/00; H04W 72/04

(52) U.S. Cl. 370/329; 370/328

(57) ABSTRACT

A method of transmitting broadcast information in a wireless communication system includes transmitting broadcast information and receiving an ACK (Acknowledgement)/NACK (Not-Acknowledgement) signal on an uplink channel from at least one mobile station in a cell, the ACK/NACK signal indicating whether the broadcast information is successfully received or not. A base station can know whether mobile stations successfully receive broadcast information or not and perform various operations to improve a reception rate of the broadcast information based on the result.

### TECHNICAL FIELD

The present invention relates to wireless communication, and, more particularly, a method of improving broadcast information reception reliability in a wireless communication system.

### BACKGROUND ART

In a wireless communication system, broadcast information is transmitted generally through a broadcast channel. The broadcast information which all users in a cell receive includes control information for radio resources allocation or synchronization. Hereinafter, the broadcast channel denotes a channel for transmitting information to all users in an area such as a cell or a sector. A multicast channel denotes a channel for transmitting information to a group of users, and an unicast channel is a channel for transmitting information to one user. A paging channel which is the broadcast channel is used by a base station to call a mobile station. The MAP which appears in the IEEE (Institute of Electrical and Electronics Engineers) 802.16 standard is one of broadcast information. Hereafter, downlink means communication from the base station to the mobile station and uplink means communication from the mobile station to the base station.

Broadcast information is needed to be received by all mobile stations in the cell. When a mobile station dose not receive the broadcast information, the mobile station cannot communicate with the base station. However, in one cell, mobile stations having good channel condition and mobile stations having poor channel condition coexist.

U.S. Patent Publication No. 2006-0154672 discloses a method for transmitting a frame including broadcast channels in a cellular wireless communication system in which a base station supports a plurality of physical channels corresponding to the broadcast channels. The frame includes separate broadcast channels for the respective physical channels.

A method is sought for enabling mobile stations in the cell to successfully receive broadcast information although channel conditions vary.

### DISCLOSURE OF INVENTION

### Technical Problem

A method of transmitting broadcast information in a wireless communication system is provided.

### Technical Solution

In an aspect, a method of transmitting broadcast information in a wireless communication system includes transmitting broadcast information and receiving an ACK (Acknowledgement)/NACK (Not-Acknowledgement) signal on an uplink channel from at least one mobile station in a cell, the ACK/NACK signal indicating whether the broadcast information is successfully received or not.

In another aspect, a method of receiving broadcast information in a wireless communication system is provided. The method includes receiving broadcast information from a base station and transmitting an ACK/NACK signal to the base station, wherein the ACK/NACK signal is information on whether the broadcast information is successfully received.

### ADVANTAGEOUS EFFECTS

A base station can know whether mobile stations successfully receive broadcast information or not and perform various operations to improve a reception rate of the broadcast information based on the result. It is possible to prevent network access delay and improve reliability of communication system.

### BRIEF DESCRIPTION OF THE DRAWINGS

FIG. 1 is a block diagram illustrating a wireless communication system.

FIG. 2 is a diagram illustrating a frame structure.

FIG. 3 is a flowchart for network initialization in accordance with an embodiment of the present invention.

FIG. 4 is a diagram illustrating a pseudo-random bit sequence for generating CDMA codes.

FIG. 5 is a flowchart for a method for transmitting broadcast information in accordance with an embodiment of the present invention.

### MODE FOR THE INVENTION

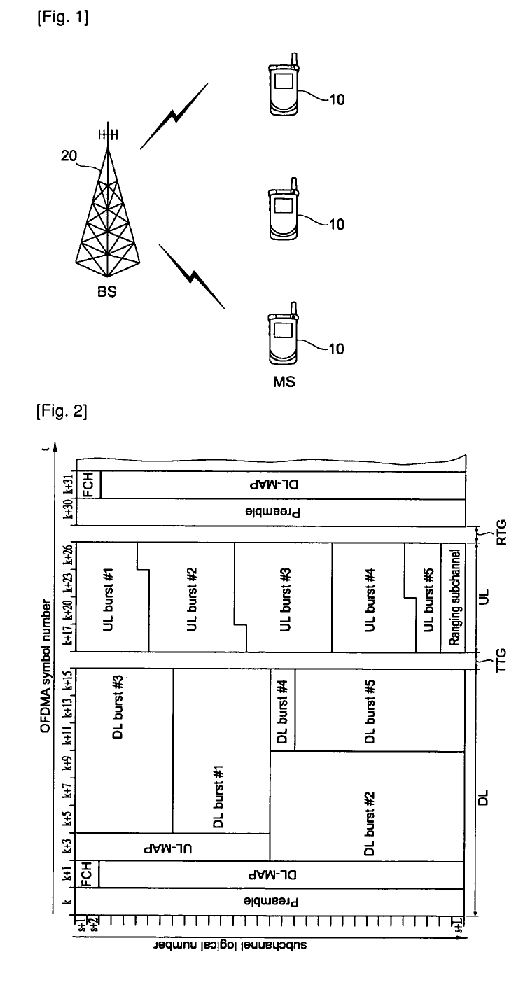

FIG. 1 is a block diagram illustrating a wireless communication system. The wireless communication system has been widely used to provide various communication services such as a voice service and a packet data service.

Referring to FIG. 1, a wireless communication system includes a mobile station (MS) 10 and a base station (BS) 20. The mobile station 10 can be fixed or mobile and can also be called another terminology, such as user equipment (UE), a user terminal (UT), a subscriber station (SS) and a wireless device. The base station 20 refers to a fixed station communicating with the mobile station 110 and can also be referred to as another terminology, such as node-B, a base transceiver system (BTS) and an access point. There exits at least one cell in the BS 20.

The wireless communication system may be based on OFDM (orthogonal frequency division multiplexing)/OFDMA (orthogonal frequency division multiple access). The OFDM uses a plurality of orthogonal sub-carriers. OFDM uses the orthogonality between inverse fast Fourier transform (IFFT) and fast Fourier transform (FFT). A transmitter transmits data by performing IFFT whereas a receiver restores data by performing FFT on received signals. The transmitter uses IFFT to combine multiple subcarriers, and the receiver uses FFT to separate the multiple subcarriers. In downlink direction, the transmitter may be a part of BS 10, and a receiver may be a part of the MS 20. In uplink direction, the transmitter may work as a part of the MS 20 and the receiver may work as a part of the BS 10.

FIG. 2 is a diagram illustrating a frame structure. A frame is a data sequence for a fixed time used by a physical specification. A frequency axis denotes an index of a subchannel which is the unit of frequency resource allocation, and a time axis denotes an index of OFDMA symbol which is an unit of time resource allocation.

Referring to FIG. 2, a frame includes an uplink frame and a downlink frame. In time division duplex (TDD), uplink and downlink transmission share the same frequency at different times. The downlink frame antecedes the uplink frame. The downlink frame starts in the order of a preamble, a frame control header (FCH), a downlink-MAP (DL-MAP), a uplink-MAP (UL-MAP), and burst zones.

There are guard times for distinguishing the uplink frame from the downlink frame at center part (between the downlink and uplink frames) and last part (next to the uplink frame). A transmit/receive transition gap (TTG) indicates a gap between a downlink burst and a subsequent uplink burst. A receive/transmit transition gap (RTG) indicates a gap between an uplink burst and a subsequent downlink burst.

The preamble is used to initially synchronize a MS with a BS, search for a cell, and estimate a frequency offset and a channel.

The FCH is the first part of the downlink frame and is broadcast information to receive all MSs in the cell. The FCH includes a DL-frame prefix as shown Table 1.

TABLE 1

| Syntax | Size | Notes |
|---|---|---|
| DL_Frame_Prefix_Format( ) { | | |
| Used subchannel bitmap | 6 bits | Bit #0: Subchannels 0-11 are used |
| | | Bit #1: Subchannels 12-19 are used |
| | | Bit #2: Subchannels 20-31 are used |
| | | Bit #3: Subchannels 32-39 are used |
| | | Bit #4: Subchannels 40-51 are used |
| | | Bit #5: Subchannels 52-59 are used |
| Ranging_Change_Indication | 1 bit | |
| Repetition_Coding_Indication | 2 bits | 00 - No repetition coding on DL-MAP |
| | | 01 - Repetition coding of 2 used on |
| | | DL-MAP |
| | | 10 - Repetition coding of 4 used on |
| | | DL-MAP |
| | | 11 - Repetition coding of 6 used on |
| | | DL-MAP |
| Coding_Indication | 3 bits | 0b000 - CC encoding used on DL-MAP |
| | | 0b001 - BTC encoding used on DL-MAP |
| | | 0b010 - CTC encoding used on DL-MAP |
| | | 0b011 - ZT CC used on DL-MAP |
| | | 0b100 to 0b111 - Reserved |
| DL-Map_Length | 8 bits | |
| reserved | 4 bits | Shall be set to zero |
| } | | |

In Table 1, ‘Used subchannel bitmap’ denotes a group of subchannels used in a PUSC zone. ‘Repetition_Coding_Indication’ denotes a repetition coding degree used in the DL-MAP, ‘Coding_indication’ denotes a coding scheme used in the DL-MAP, and ‘DL-MAP_Length’ indicates a length of a DL-MAP message.

The DL-MAP is a zone where a DL-MAP message is transmitted. The DL-MAP includes information on which MS downlink bursts are for, and in which zone the downlink burst are positioned. The DL-MAP message defines access of a downlink channel and is broadcast information and includes a configuration change count of a downlink channel descriptor (DCD) and a base station identifier (ID). The DCD describes the downlink burst profile which is applied to a current MAP. The downlink burst profile provides characteristics of a downlink physical channel, and a BS regularly transmits the DCD through the DCD message.

The UL-MAP is a zone where a UL-MAP message is transmitted. The UL-MAP includes information on uplink bursts that are transmitted by a MS. The UL-MAP message defines access of an uplink channel and is broadcast information. The UL-MAP message carries a configuration change count of an uplink channel descriptor and a valid starting time of uplink allocation defined by the UL-MAP. The UCD describes an uplink burst profile. The uplink burst profile provides characteristics of an uplink physical channel and is periodically transmitted through the UCD message. The UCD message includes information on a backoff window for ranging.

A slot is a minimum possible data allocation unit and is defined as a time and a subchannel. One burst is transmitted in at least one slot. In a frame, contiguous subchannels may be physically contiguous with each other or may not. For example, a (s+1)-th subchannel may physically be contiguous with a (s+2)-th subchannel or not. It is because subchannels are allocated to physical subcarriers to improve frequency selectivity.

Mapping logical subchannels to physical subcarriers is referred to as subchannel allocation or permutation. There are various subchannel allocation schemes such as diversity subchannel allocation scheme, and adaptive modulation and coding (AMC) allocation scheme. The diversity subchannel allocation scheme includes full usage of carrier (FUSC) and partial usage of sub-carrier (PUSC). The diversity subchannel allocation scheme improves frequency selectivity by distributing physical subcarriers to generate logical subchannels. On the contrary, the AMC subchannel allocation scheme uses localized subcarriers to generate logical subchannels. A BS improves data rate by adjusting modulation and coding scheme according to channel state of an AMC subchannel.

In uplink direction, a subchannel may be constructed of a plurality of tiles. For example, a subchannel is constructed of six tiles, and one burst may be transmitted in three OFDM symbols and one subchannel. In PUSC permutation, each tile may be composed of four contiguous subcarriers on three OFDMA symbols. Selectively, each tile may be composed of three contiguous subcarriers on three OFDMA symbols. A bin includes 9 contiguous subcarriers on three OFDMA symbols. A band denotes a group of four rows of a bin, and an AMC subchannel is composed of six contiguous bins at the same band.

In the frame, a preamble, FCH, DL-MAP, and UL-MAP are control signals which provides control information. Since the control information is broadcast information that must to be transmitted to all users, the preamble, FCH, DL-MAP, and UL-MAP are transmitted through a broadcast channel. Since a downlink burst and an uplink burst are for a specific MS or a set of MSs, the downlink burst or the uplink burst may be transmitted through a multicast channel or a unicast channel.

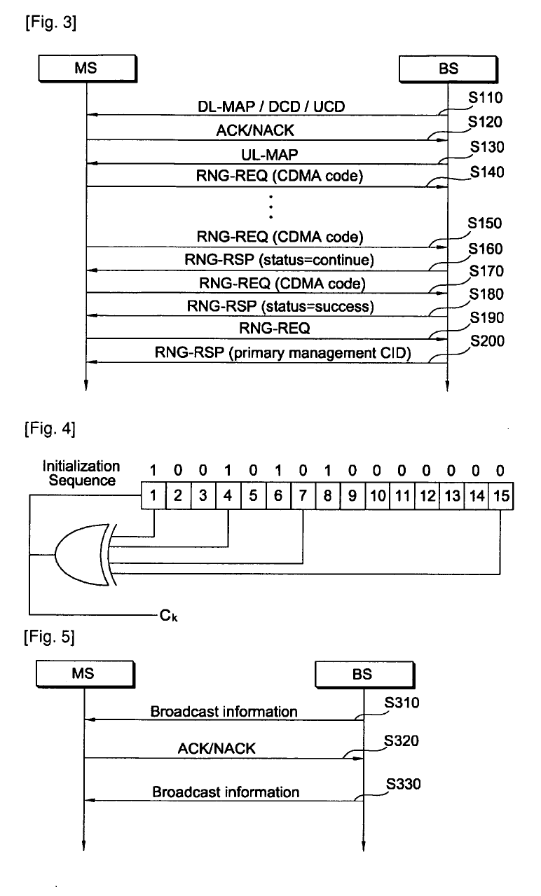

FIG. 3 is a flowchart for network initialization in accordance with an embodiment of the present invention. The network initialization is a process that a MS initially enters a network. In the network initialization, initial ranging is a process for obtaining an accurate timing offset between a MS and a BS and adjusting transmission power at an initial stage.

Referring to FIG. 3, a MS reads a DL-MAP message transmitted from a BS at step S110. The MS needs to receive a downlink broadcast channel first for initialization. The MS scans a downlink channel, receives a frame, and synchronizes with the BS through a preamble. If the MS receives at least one of DL-MAP messages, the MS can acquire medium access control (MAC) synchronization. In order to receive the DL-MAP message, the MS must detect repetition coding scheme or coding scheme of DL-MAP by reading FCH following the preamble. The MS reads a downlink frame prefix by decoding the FCH.

After obtaining MAC synchronization, the MS can subsequently receive a DL-MAP message, a DCD message, and an UCD message. After synchronization, the MS obtains transmission parameters for an uplink channel by reading an UCD message from the BS. The UCD message includes information on radio resources used to transmit a ranging request. The UCD message specifies at least one of groups of 6 or 8 contiguous subchannels where contention based ranging is performed. The contention based ranging means that at least one of MSs can transmit the ranging request through the same ranging slot at the same time.

At step S120, the MS transmits an Acknowledgement(ACK)/Not-Acknowledgement(NACK) signal according to whether the mobile station successfully receives DL-MAP or not. The ACK signal means the MS successfully receives DL-MAP, and the NACK signal means that the MS fails to receive DL-MAP. The success of DL-MAP reception means the MS can read information on DL-MAP by successfully decoding DL-MAP. When the MS fails to decode FCH, the mobile station can transmit the NACK signal. Or, the MS can transmit the NACK signal when the MS fails to decode the DL-MAP after reading the FCH.

The BS can confirm overall reception rate of DL-MAP in the cell through the ACK/NACK signal. If the overall reception rate is lower than a predetermined threshold, the BS can adjust coding scheme or transmission power of broadcast information to improve the reception rate. For example, if the number of NACK signals is larger than a predetermined threshold, a repetition coding degree of DL-MAP may be increased or coding scheme may be changed.

Radio resources for the ACK/NACK signal may be allocated on an uplink frame in advance to transmit the ACK/NACK signal. The radio resources for the ACK/NACK signal may be reserved in the uplink frame. An uplink channel for transmitting the ACK/NACK signal is referred as an ACK/NACK channel. The ACK/NACK channel may be a dedicated channel for the ACK/NACK signal or a temporary channel which is temporarily used for the ACK/NACK signal. In the ACK/NACK channel, the ACK/NACK signal can be multiplexed with other data or a control signal such as a channel quality indicator (CQI) which represents downlink channel condition.

The ACK/NACK signal is transmitted based on contention. The contention based transmission means that a plurality of MSs can transmit the ACK/NACK signal through the same ACK/NACK channel.

In order not to change basic structure of a frame, at least one of tiles over three OFDMA symbols can be allocated for radio resources for the ACK/NACK signal in PUSC or optional PUSC, and at least one of bins over one OFDMA symbol can be allocated in AMC subchannel allocation. Pilot may be used or may be not used according to coherent detection or non-coherent detection. If it is necessary to continuously allocate pilot, a location of pilot on a tile or bin can be changed.

At step S130, in order to find an initial ranging interval, the MS reads a UL-MAP message. The BS allocates the initial ranging interval constructed of at least one of transmission opportunities. The transmission opportunity means allocation provided from UL-MAP in order to enable a predetermined group of authenticated mobile stations to transmit ranging requests. The MS located at any position in the cell can successfully receive UL-MAP by improving a reception rate of MAP through the ACK/NACK signal.

At step S140, the MS transmits a ranging request (RNG-REQ) message. The ranging request message is transmitted from the MS at an initial stage in order to decide network delay and to request change of transmission power and/or downlink burst profile. The MS randomly selects a ranging slot within a backoff window and also randomly selects a code division multiple access (CDMA) code from a set of allowed codes. The CDMA code may use a pseudo-random bit sequence (PRBS) binary phase shift keying (BPSK) code. MS which transmit ranging request messages through the same ranging slot at the same time are on the contention.

At step S150, if no response is transmitted from the BS, the MS transmits a ranging request message at the next contention slot with increased power level.

At step S160, the BS transmits a ranging response (RNG-RSP) message that informs the MS that the ranging request message is successfully received. Since the BS is not aware of which MS transmits a CDMA code, the ranging response message includes the received CDMA code in order to enable the MS to recognize itself through the CDMA code. The ranging response message is a broadcast message. The base station decides a symbol timing offset for transmission delay, a frequency offset for Doppler shift or for inaccuracy of an oscillator, and receiving power. The BS transmits correction to the MS using this information. The MS continues ranging until power, timing, and frequency are aligned. The ranging response message includes a ranging status. If a ranging status indicates ‘continue’, the MS performs correction assigned in the ranging response message and then registers a different CDMA code after predetermined backoff delay.

If the ranging status of the ranging response message indicates ‘continue’, the MS continuously transmits a CDMA code through the ranging request message at step S170. The MS updates timing and power according to the ranging response message and transmits the ranging request message.

At step S180, the BS transmits the ranging response message of which ranging status is ‘success’ and allocates a bandwidth to the MS. The BS continues to perform a fine tuning process through the ranging response message. The ranging request/response processes are repeated until the BS transmits a ranging response message including the ranging status which is successful or abort.

At step S190, the MS transmits a ranging request message including a identifier of its own. As the identifier, the MS may use a unique identifier such as a MAC address or a temporary identifier.

At step S200, the BS identifies the MS through the identifier and transmits a ranging response message including a primary management contention identifier (CID). The connection identifier (CID) is a value that confirms connection between the BS and the MS at MAC, and the primary management connection identifier is CID for connection established during initial ranging and used to transmit delay-tolerant MAC messages. With this, the initial ranging is completed.

After completing the initial ranging, the BS and the MS negotiate basic capability and exchange an authorization key. The MS transmits a registration request (REG-REQ) message. Then, the BS registers by transmitting a registration response (REG-RSP) message, establishes IP connectivity, establishes time of day, and transmits supplementary operating parameters. With this, connection between the BS and the MS is established.

Broadcast information such as DL-MAP and UL-MAP needs to be transmitted robustly in order to enable all of MSs in the cell to successfully receive. That is, all of MSs need to receive a broadcast channel where DL-MAP is transmitted. According to Table 1, the BS can select one of 1, 2, 4, and 6 as a repetition coding degree. When the MS is located at a boundary of the cell where channel condition is usually poor, the MS may not read DL-MAP. The MS cannot even transmit a signal informing inability of reading DL-MAP because the MS cannot be aware of any uplink radio resource allocation.

If the MS can transmit a channel quality indicator (CQI) to the BS, the BS can transmit DL-MAP more robustly according to the CQI. If the BS does not even obtain the CQI, the BS cannot be aware of that the MS can read or cannot read DL-MAP. Also, all of MSs cannot transmit CQI on overall bandwidths. Even when it is assumed that the MS can transmits the CQI, the MS generally transmits the CQI when comparative long interval. Therefore, it may be difficult to immediately reflect the CQI every time at which broadcast information is provided.

According to the proposed method, the BS can properly determine a repetition coding degree and/or a coding scheme of broadcast information by receiving information on whether the MS successfully receives the broadcast information or not. A predetermined zone in the uplink frame is reserved for radio resources for the ACK/NACK signal. Since the MS already knows the ACK/NACK radio resources, the MS can transmit the ACK/NACK signal although the MS cannot receive UL-MAP. The BS can increase the repetition coding degree of DL-MAP if number of the NACK signals is larger than a predetermined number. Also, the BS can detect overall channel condition in the cell through the ACK/NACK signal and performs necessary operations for enable all of MSs to receive the broadcast information.

The MS may transmit one of the ACK signal and the NACK signal. The MS may transmit only the NACK signal without transmitting the ACK signal and the BS may measure a ratio of MSs that transmit the NACK signal in entire MSs.

Hereinafter, a method for transmitting an ACK/NACK signal is disclosed. The method for transmitting the ACK/NACK signal may differ according to whether a MS can adjust transmission power or not.

In an embodiment, the same ACK/NACK signal can be defined for all of MSs in a cell when power control for uplink transmission is performed. After defining a code for each of the ACK signal and the NACK signal, a MS can transmit the ACK signal or the NACK signal through an ACK/NACK channel. If the closed loop uplink transmission or power control for uplink transmission is performed, it is not important that the MS transmits the ACK signal or the NACK signal. The BS is only required to know a ratio of ACK signals and NACK signals received through the ACK/NACK channel. If the BS can receive signals of all MSs with the same power by performing uplink power control, transmission power of ACK signals and NACK signals can equally be set. That is, two signals are defined for the ACK signal and the NACK signal, and all of the MSs transmit one of two signals according to ACK or NACK. For example, it is assumed that the ACK signal uses a code (1,1,1,1), and the NACK signal uses a code (1, −1, 1, −1). The ACK signal is orthogonal to the NACK signal. If three MSs are in a cell, a first MS MS1 and a second MS MS2 transmit an ACK signal and a third MS MS3 transmits the NACK signal, a received signal y at the BS may be expressed as shown:

$$\begin{matrix}MathFigure 1 & \\ \begin{matrix} MS 1 & = & 1 & 1 & 1 & 1 \\ MS 2 & = & 1 & 1 & 1 & 1 \\ + MS 3 & = & 1 & - 1 & 1 & - 1 \\ y & = & 3 & 1 & 3 & 1\end{matrix} & [ Math . 1 ]\end{matrix}$$

If the received signal y is correlated with the ACK signal, it becomes 8. If the received signal y is correlated with the NACK signal, it becomes 4. Therefore, a ratio of the ACK signal and the NACK signal becomes 2:1. The BS can adjust a repetition coding degree and/or a coding scheme of broadcast information more robustly when the ratio of the NACK signal is greater than a predetermined threshold such as 50%. According to this scheme, a code assigned to the ACK/NACK signal can be easily generated. However, if power control of MS is not accurately performed, it is difficult to obtain an accurate ratio of the ACK/NACK signal because the ratio of the ACK/NACK signal is changed according to power.

In another embodiment, a ratio of ACK/NACK signal can be obtained by individually detecting ACK/NACK signals of each MS when power control for uplink transmission is not performed. If ACK/NACK radio resources can be allocated to all of MSs in the cell, it could be overhead. Therefore, a limited resource can be allocated. Various methods may be used to transmit ACK/NACK signals through the limited resource.

For example, ACK/NACK signals between MSs can be transmitted based on code division multiplexing (CDM). Each of the MSs uses a distinct code as the ACK/NACK signal and orthogonality of the distinct code is used to distinguish MSs. By allocating an orthogonal code to each MS, the MS may be identified through the orthogonal code.

For another example, one CDMA code may be selected from a set of CDMA codes based on contention. A MS can transmit the ACK/NACK signal by randomly selecting one CDMA code from the set of CDMA codes.

FIG. 4 is a diagram illustrating a pseudo-random bit sequence (PRBS) for generating CDMA codes.

Referring to FIG. 4, the PRBS realizes a polynomial generator 1+x¹+x⁴+x⁷+x¹⁵. A CDMA code is a subsequence of pseudo noise appeared in an output Ck. Although CDMA codes have orthogonality, MSs can transmit same CDMA code at the same time. It is referred as contention based scheme. If a length of the CDMA code is 144 bits and binary phase shift keying (BPSK) is used, three subchannels may be used because 48 data subcarriers can be used per each subchannel in case of PUSC or optional PUSC (48×3=144). If the PRBS of FIG. 4 is used, total 288 of CDMA codes can be generated. A half of the CDMA codes can be used for an ACK signal, and the others can be used for an NACK signal.

If the number of MSs per a cell is too large, more subchannels may be allocated to the ACK/NACK signal. For example, three more three of subchannels can be allocated as ACK/NACK radio resources. The ACK/NACK radio resources can be allocated to each of MSs according to CID. For example, if the CID is multiple of 3, each MS allocates ACK/NACK radio resources at first three subchannels. If the OD is multiple of 3+1, each MS allocates ACK/NACK radio resources at second three subchannels. If the CID is multiple of three+2, each MS allocates ACK/NACK radio resources at third three subchannel zone.

As still another example, the MS may use constant amplitude zero auto-correlation (CAZAC) sequence for the ACK/NACK signal.

In general, there are two types of CAZAC sequences, GCL sequence and Zadoff-Chu (ZC) sequence. The two types of sequences have a conjugate relation: For example, the ZC sequences can be obtained by applying conjugate on the GCL sequence.

In ZC sequence, the k-th element c(k) of a root ZC sequence which corresponds to a root index M may be expressed as shown:

$$\begin{matrix}MathFigure 2 & \\ c ( k ) = exp \{ - \frac{j π Mk ( k + 1 )}{N} \} , for N odd \\ c ( k ) = exp \{ - \frac{j π {Mk}^{2}}{N} \} , for N even & [ Math . 2 ]\end{matrix}$$

where N is the length of the root ZC sequence. The root index M is relatively prime to N. If N is a prime number, the number of root indexes of the ZC sequence would be N−1

The ZC sequence c(k) has the following three characteristics.

$$\begin{matrix}MathFigure 3 & \\ \vert c ( k ) \vert = 1 for all k , N , M & [ Math . 3 ] \\ MathFigure 4 & \\ {R}_{M , N} ( d ) = \{ \begin{matrix}1 , & for d = 0 \\ 0 , & for d \neq 0\end{matrix} & [ Math . 4 ] \\ MathFigure 5 & \\ {R}_{{M}_{1} , {M}_{2} ; N} ( d ) = const for all {M}_{1 ,} {M}_{2} & [ Math . 5 ]\end{matrix}$$

Equation 3 means that the size of the ZC sequence is always 1, and Equation 4 means that auto-correlation of the ZC sequence is expressed as a Dirac-delta function. Here, the auto-correlation is based on circular correlation. Equation 5 means that cross correlation is always a constant.

As an ACK/NACK signal, cyclic-shifted ZC sequences can be allocated to each of MSs, or ZC sequences having different root indexes are allocated to each of MSs.

Hereinafter, a method for allocating a ZC sequence to an AMC subchannel is disclosed. One AMC subchannel includes six consecutive bins and one bin includes eight data subcarriers and a pilot subcarrier. Therefore, an AMC subchannel includes 48 data subcarriers. If length 6 of a ZC sequence is used, it is possible to allocate maximum 6 ZC sequences to 6 MSs. If the number of the AMC subchannels is N, 6N ZC sequences can be generated and 6N MSs can be multiplexed. In order to load an ACK/NACK signal at 48N data subcarriers, eight modulated signals generated by spreading or repeating 1-bit ACK/NACK signals can be multiplied with 6N ZC sequences. The BS can reproduce the ACK/NACK signal by using the eight modulated signals acquired by de-spreading the ZC sequences.

In case of PUSC or optional PUSC, it is possible to spread a ZC sequence when performing logical mapping since hopping by tiles occurs. Alternatively, the ZC sequence may be spread according to physical mapping order.

It is also possible to load one long CAZAC sequence on overall subchannels allocated to ACK/NACK radio resources. A MS may transmit the ACK/NACK signal randomly or according to a CID by encoding the ACK/NACK signal based on a predetermined cyclic-shift value. Or, the MS may divide the overall subchannels into a plurality of subchannels and use a cyclic-shift value for a short ZC sequence for each of the subcahnnels. In coherent detection, pilot can use a ZC sequence identical to the ACK/NACK signal.

The allocation method for the ZC sequence may be identically used for another orthogonal sequence such as a Walsh code. If the number of MSs is too large to identify each of the MSs using one orthogonal sequence, the number of subchannels may increase or more than two orthogonal sequences may be combined and used to identify the MSs. For example, it is assumed that 24 subcarriers and 12 OFDMA symbols are used. Under this assumption, maximal 24×12 MSs can be accommodated using a ZC sequence having length of 24 in the frequency domain and a Walsh code having length of 12 in the time domain. Various methods may be adapted to generate the ZC sequence having length of 24 or the Walsh code having length of 12, such as truncation or zero padding. Or, if a ZC sequence is loaded at 1.5 tiles (12 data subcarriers) and four Walsh codes are loaded, maximal 12×4=48 MSs can be multiplexed in one subchannel. Several subchannels may be further allocated depending on the number of users in the cell.

FIG. 5 is a flowchart for a method for transmitting broadcast information in accordance with an embodiment of the present invention.

Referring to FIG. 5, a BS transmits broadcast information through a broadcast channel at step S310. The broadcast information may be information on a downlink control channel or information on radio resource allocation.

A MS transmits an ACK/NACK signal according to whether to successfully receive broadcast information or not at step S320. The mobile station receives broadcast information on the broadcast channel. If the MS successfully decodes the broadcast information, the MS transmits an ACK signal. On the contrary, if not, the MS transmits an NACK signal. Or, the MS may transmit only one of the ACK signal and the NACK signal. The MS may only transmit the NACK signal without transmitting the ACK signal. ACK/NACK radio resources may be setup at an uplink frame in advance for transmitting the ACK/NACK signal.

At step S330, the BS transmits new broadcast information through the broadcast channel at a different transmission time. The BS determines whether MSs in the cell successfully receive broadcast information or not by using the ACK/NACK signals and adjusts transmission power of the broadcast channel or MCS of broadcast information, thereby improving reception rate of broadcast information.

Every function as described above can be performed by a processor such as a microprocessor based on software coded to perform such function, a program code, etc., a controller, a micro-controller, an ASIC (Application Specific Integrated Circuit), or the like. Planning, developing and implementing such codes may be obvious for the skilled person in the art based on the description of the present invention.

Although the embodiments of the present invention have been disclosed for illustrative purposes, those skilled in the art will appreciate that various modifications, additions and substitutions are possible, without departing from the scope of the invention. Accordingly, the embodiments of the present invention are not limited to the above-described embodiments but are defined by the claims which follow, along with their full scope of equivalents.

1. A method of transmitting broadcast information in a wireless communication system, the method comprising:
transmitting broadcast information; and
receiving an ACK (Acknowledgement)/NACK (Not-Acknowledgement) signal on an uplink channel from at least one mobile station in a cell, the ACK/NACK signal indicating whether the broadcast information is successfully received or not.

2. The method of claim 1, wherein radio resources for the uplink channel is reserved on an uplink frame.

3. The method of claim 1, wherein the broadcast information is information on downlink radio allocation.

4. The method of claim 1, wherein the broadcast information is information on uplink radio allocation.

5. The method of claim 1, wherein the ACK/NACK signal is multiplexed with another control signal in the uplink channel.

6. The method of claim 1, wherein the ACK/NACK signal uses an orthogonal code allocated to each mobile station.

7. A method of receiving broadcast information in a wireless communication system, the method comprising:
receiving broadcast information from a base station; and
transmitting an ACK/NACK signal to the base station, wherein the ACK/NACK signal is information on whether the broadcast information is successfully received.

8. The method of claim 7, wherein the ACK/NACK signal utilizes code division multiplexing (CDM) between mobile stations.

9. The method of claim 7, wherein the ACK/NACK signal is transmitted through an ACK/NACK channel.

10. The method of claim 9, wherein the ACK/NACK signal is multiplexed with another control signal in the ACK/NACK channel.
